(19) United States
(12) Patent Application Publication
(10) Pub. No.: US 2025/0153968 A1
(43) Pub. Date: May 15, 2025

(54) Device and Method for Removing a Section from a Web and System for Processing a Web

(71) Applicant: LTS Lohmann Therapie-Systeme AG, Andernach (DE)

(72) Inventors: Daniel Buchholz, Neuwied (DE); Nikolaj Tissin, Bonn (DE); Daniel Sauer, Koblenz (DE); Ralf Ingo Stein, Dierdorf (DE)

(21) Appl. No.: 18/947,030

(22) Filed: Nov. 14, 2024

(30) Foreign Application Priority Data
Nov. 15, 2023 (DE) 10 2023 131 837.3

(51) Int. Cl. B65H 35/00; B26D 7/00; B26D 7/18; B26D 7/26

(52) U.S. Cl. CPC B65H 35/0086; B26D 7/0006; B26D 7/18; B26D 7/2628; B65H 2513/10

(57) ABSTRACT

A device for removing a section from a web, in particular a film web, including at least one separating device for separating the section out of the web, and a guiding device. The guiding device movably guides the separating device in the direction of movement of the web. The invention also includes a system for processing a web and method for removing a section from a web.

### CROSS-REFERENCE TO RELATED APPLICATION

This application claims priority to German Patent Application No. 10 2023 131 837.3 filed Nov. 15, 2023, the disclosure of which is hereby incorporated by reference in its entirety.

### BACKGROUND OF THE INVENTION

### Field of the Invention

The invention relates to a device and method for removing a section from a web and a system for processing a web.

### Description of Related Art

When processing web-shaped materials, in particular film webs, such as in the production of transdermal patches, one possible process step is to remove a section, in particular a sample, such as a random sample, from a web. So far, sections have generally been removed manually by separating the section out of the web by hand.

On the one hand, the conveying movement of the web must be stopped for this purpose so that the section can be separated safely and/or precisely. Stopping the web leads to production downtime and/or problems in the operating process.

On the other hand, it is possible to remove the sections while the web is running. This leads to numerous problems. For example, there is a risk of injury to the personnel carrying out the work, damage to the remaining web area and/or imprecise separation of the section. The imprecise separation can lead to the separation of sections of different sizes and/or separation at different points, for example, so that systematic, repeatable sampling is not possible.

### SUMMARY OF THE INVENTION

The object of the invention is to improve the removal of sections from a web, in particular to systematize it.

According to the invention, the object is achieved by a device for removing a section from a web as described herein, a system for processing a web as described herein, and a method for removing a section from a web as described herein.

The device according to the invention for removing a section, preferably a sample, particularly preferably a random sample from a web, is in particular a device for removal from a film web. The device comprises at least one separating device for separating the section out of the web. Furthermore, the device comprises a guiding device. The guiding device movably guides the separating device in a direction of movement of the web. The direction of movement corresponds in particular to a longitudinal direction of the web. It is preferred that the guiding device guides the separating device parallel and/or linearly to the direction of movement of the web.

In a preferred embodiment, the guiding device is set up to accelerate the separating device in the direction of movement of the web. In particular, the guiding device comprises at least one actuator, preferably a motor for accelerated movement of the separating device. It is preferred that the guiding device moves the separating device in a stroke movement, i.e. in particular back and forth. The stroke length corresponds in particular to the length of travel of the separating device with the web. In particular, the stroke length corresponds to 50-5000 mm, preferably 100-1000 mm, particularly preferably 300-800 mm.

In a preferred embodiment, the guiding device is set up to move the separating device at a speed synchronized with the web speed, in particular at an identical speed. It is therefore preferred that the separating device is moved at a speed that corresponds to the speed of the web. In particular, the separating device is moved along with the web so that the separating device is moved parallel to the web and/or at the same speed as the web. Preferably, the separating device is moved at a speed of 1-100 m/min, preferably 3-50 m/min, particularly preferably 4.5-32 m/min. It is preferred that the separating device is accelerated to the speed of the web within the stroke length and particularly preferably maintains the speed during a further part of the stroke length. It is preferred that the separating device is moved parallel to the web at a constant speed over a period of 0.1 s to 2 s, particularly preferably from 0.2 s to 1 s.

In a preferred embodiment, the separating device is set up to separate the section when the web speed is reached and/or during a movement of the separating device at web speed. During the separation process, the separating device is moved at a constant speed, in particular. It is preferred that the separating device is moved back to the starting position after separation, in particular moved to the start of the stroke.

In a preferred embodiment, the separating device comprises at least one sensor for detecting the web speed. The sensor is in particular a contactless sensor or a contact-based sensor, so that the sensor is contactless to the web or that the sensor is in contact with the web. It is preferred that the guiding device comprises the sensor, in particular is connected thereto. In particular, the sensor is a mechanical and/or optical and/or magnetic sensor. Preferably, the guiding device moves the separating device at the detected speed.

In a preferred embodiment, the sensor has a rotary encoder, in particular a contact-based rotary encoder, wherein it is preferred that the sensor consists of the rotary encoder. The rotary encoder has, for example, at least one wheel that comes into contact with the web, in particular runs on the web on one or both sides. Alternatively or additionally, the sensor can have an ultrasonic sensor or a laser sensor.

In a preferred embodiment, the separating device comprises a controller. In particular, the controller has a processor, preferably a computer. The controller is set up to synchronize the speed of the separating device with the web speed and/or to trigger the separation of the section out of the web when the speed of the separating device is synchronized with the web speed. The synchronized speed is in particular a speed that corresponds to the web speed, preferably is identical thereto. It is preferred that the guiding device comprises the controller, in particular is connected thereto. As an alternative or in addition to the sensor, it is possible, for example, that the controller detects the web speed from a web control unit that controls the web speed, in particular by receiving it via data transmission. It is then possible for the separating device to be moved at web speed based on this detected speed.

In a preferred embodiment, the separating device is displaceable, in particular adjustable, transversely to the web. In particular, the separating device is displaceable in a manual or actuated manner, e.g. motorized. In particular, the adjustable separating device is configured to be fixable so that it can be detachably fixed in the transverse direction. In particular, it is possible for the device to have displaceable and fixed separating devices. Due to the displaceability, it is possible in a particularly advantageous manner that sections can be removed at different points in the transverse direction or that sections can be removed variably at different web widths.

In a preferred embodiment, the separating device comprises at least one cutting device. The cutting device is preferably a circular cutter, in particular a rotating one. The circular cutter has at least one, preferably at least two, particularly preferably four cutting edges. On the other hand, it is also possible for the circular cutter to have six or eight cutting edges. In particular, the cutting edge is a knife. In particular, the cutting device is configured to pierce the web and then rotate to cut it out. On the other hand, it is preferably possible that the cutting device is first accelerated, in particular rotated, and then inserted into the web, in particular pierced. It is preferred that the cutting device rotates depending on the number of cutting edges. In particular, the cutting device rotates by at least 90° or at least 180° or at least 360°. It is also possible for the cutting device to be rotated by at least 45° or at least 60°.

Instead of or in addition to the circular cutter, it is preferably possible for the separating device to have a punch as a cutting device for cutting out the sections. It is preferred that the separating device has a counter-pressure device, in particular a counter-pressure plate, e.g. with a recess for the cutting device, opposite the web in relation to the cutting device. In particular, it is possible that the separating device has an ejection device, e.g. movable relative to the cutting device, for ejecting the section cut out of the web. It is preferred that the separating device comprises a motor for actuating the cutting device and/or the counter-pressure device.

In a preferred embodiment, the cutting device and/or the counter-pressure device and/or the ejection device of the separating device is configured to be movable perpendicular to the web. Preferably, the cutting device and the counter-pressure device are movable towards each other. The separating device, in particular the cutting device and/or the counter-pressure device and/or the ejection device, is preferably pneumatically and/or hydraulically actuated, wherein it is preferred that at least the perpendicular displaceability to the web is pneumatically and/or hydraulically actuated. Preferably, the separating device comprises a pneumatically controlled cylinder. On the other hand, it is possible in particular that the separating device, in particular the cutting device and/or the counter-pressure device and/or the ejection device, is electrically actuated, for example by means of an electric cylinder.

In a preferred embodiment, the device comprises at least one collecting device for collecting the separated sections. In particular, the device comprises a separate collecting device for each separating device. In particular, the collecting device has an extendable drawer for removing the collected sections. The collecting device is in particular connected to the guiding device, preferably attached thereto. It is preferred that the collecting device is arranged such that the cut-out sections fall into the collecting device due to gravity and/or acceleration by the separating device. It is preferred that the device, e.g. the guiding device, comprises a sensor that detects a position of the drawer of the collecting device. The device, in particular the controller of the device, is particularly set up such that the separating device is blocked for separation if the sensor detects an extended position of the drawer.

In a preferred embodiment, the device comprises several separating devices for separating several sections, which are arranged next to each other, in particular transversely to the web. If the device comprises several separating devices, it is preferably possible for one, several or all separating devices to be adjustable transversely to the web. If the device comprises several separating devices, it is also preferred that one, several or all separating devices are arranged transversely to the web in a fixed, in particular non-adjustable, position. It is preferred that the device has three separating devices arranged next to each other transversely to the web, wherein it is particularly preferred that one or both outer separating devices are adjustable transversely to the web.

In a preferred embodiment, the guiding device is configured as a gantry system that guides the separating device on one or both sides of the web. The gantry system guides the separating device in particular in the longitudinal direction of the web and movably relative to the web. Preferably, a cutting device of the separating device is guided on one side of the web and a counter-pressure device of the separating device is guided on the other side of the web. In particular, the gantry system comprises a gantry, with the at least one separating device preferably being connected to the gantry.

In a preferred embodiment, the guiding device comprises a linear module, in particular having a toothed belt axis, for linear guidance of the separating device relative to the web. The linear module guides the portal of the gantry system in particular. The linear module is preferably configured for linear movement in the longitudinal direction of the web. In particular, the linear module has a linear bearing, e.g. with a rail. Preferably, the guiding device, in particular the linear module, comprises a drive, such as a motor, in particular with a toothed belt axis for moving the separating device. It is preferred that the guiding device comprises two linear modules, in particular on both sides of the web in the transverse direction.

In a preferred embodiment, the device comprises a web threading connected to the guiding device for arranging the web relative to the separating device. The web threading is connected to the gantry in particular. It is preferred that the web threading comprises at least one guiding roller. The at least one guiding roller is located in particular on the opposite side of the web to the cutting device. Preferably, the web threading comprises two guiding rollers, in particular in the longitudinal direction on both sides of the gantry. In particular, the web threading fixes the web, preferably in a vertical direction, particularly preferably against a stroke movement of the cutting device.

The system for processing a web according to the invention is in particular a system for processing a film web. The system comprises a web conveying device for conveying the web and the device according to the invention for removing a section from a web. The device for removing a section from the web is arranged such, in particular relative to the web, that the section can be removed from the web. In particular, the web conveying device comprises at least two rollers for conveying the web. At least one of the rollers in particular is driven. Preferably, the system also comprises a web, in particular a film web, conveyed by the web conveying device.

The method according to the invention for removing a section, preferably a sample, particularly preferably a random sample from a web is in particular a method for removing a section from a film web. The method comprises the step of moving a separating device, in particular in the direction of movement of the web, at a speed synchronized with the web speed, in particular at an identical speed. The speed of movement of the separating device therefore corresponds in particular to the speed of movement of the web. In particular, the separating device is moved parallel to the web, preferably above the web. In other words, it is preferred that the separating device is moved such that the separating device moves along with the web. A further step in the process consists of separating the section out of the web. In particular, the separation is performed when the web speed is reached by the separating device and/or during a movement of the separating device at web speed. The separating device is moved in particular by means of a guiding device which corresponds to the guiding device of the device according to the invention. The separating device corresponds in particular to the separating device of the device according to the invention.

The web of the device, the system and/or the method is in particular a film web, preferably for the production of transdermal patches and/or oral films. The film web preferably has several layers. For example, the film web has at least one film, preferably several films, an adhesive, preferably an adhesive layer and/or an active ingredient, preferably an active ingredient layer. The adhesive and the active ingredient, in particular the adhesive layer and the active ingredient layer, can preferably be provided as a combination layer. The web is preferably a continuous web. In particular, the web has a width of 300-3000 mm, preferably 500-2000 mm, particularly preferably 960-1600 mm. In particular, the web moves in the longitudinal direction at a web speed. Preferably, the web has a speed of 1-100 m/min, preferably 3-50 m/min, particularly preferably 4.5-32 m/min.

It is preferred that the method according to the invention is carried out with a device or system having at least one feature of the device according to the invention or the system according to the invention for removing a section from a web. The device according to the invention or the system according to the invention for removing a section from a web is configured in particular for carrying out a method having at least one feature of the method according to the invention.

It is preferred that one or more of the subjects according to the invention, i.e. the device and/or the system and/or the method, each have one or more features of the other subjects according to the invention.

### BRIEF DESCRIPTION OF THE DRAWING

In the following, the invention is described in more detail by means of a preferred embodiment with reference to the accompanying drawing.

FIG. 1 shows a perspective view of a preferred embodiment of a device according to the invention for removing a section from a web.

### DESCRIPTION OF THE INVENTION

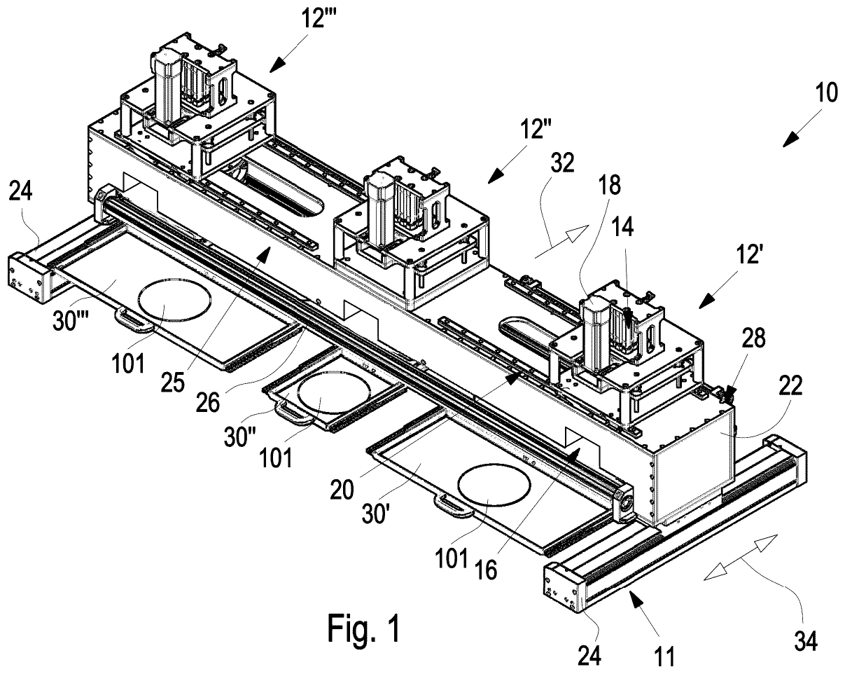

The embodiment shown in FIG. 1 is a device 10 for removing a section in the form of a sample 101 from a film web (the film web is hidden and not illustrated in FIG. 1). Device 10 comprises a guiding device 11 in the form of a gantry system. Guiding device 11 comprises a gantry 22, which is guided by two linear modules 24 to be movably displaceable in one direction of movement (shown by arrow 34). In particular, the linear modules 24 have a driving device, preferably comprising a toothed belt axis, for moving gantry 22.

Two guiding rollers 26, 28 of a web threading 25 are connected to gantry 22 on both sides of gantry 22.

The web, in particular the film web, can be guided inside gantry 22 by means of web threading 25, in particular the guiding rollers 26, 28.

In doing so, the web runs in one direction of movement (shown by arrow 32), also referred to as the longitudinal direction, at a web speed. In particular, the directions of movement of the web and the gantry are coaxial.

Device 10 comprises a sensor (not illustrated), preferably connected to gantry 22, for detecting the web speed. For this purpose, it is preferred that the sensor comprises a rotary encoder that detects the speed of the web in contact with the web. For this purpose, the sensor preferably comprises a measuring wheel that runs on the web. It is also preferred that a counter-pressure wheel is provided, which rests on the opposite side of the web.

The driving device accelerates gantry 22, wherein in particular such an acceleration takes place that gantry 22 has a speed that is synchronized with the web speed determined in particular by means of the sensor. It is particularly preferred that gantry 22 is moved at a speed corresponding to the web speed, so that in other words gantry 22 moves along with the web. In doing so, gantry 22 moves parallel to the web.

When gantry 22 has reached the web speed, sections, in particular samples 101, are separated out of the web. For this purpose, three separating devices 12′, 12″, 12″′ are connected to gantry 22. Each separating device 12′, 12″, 12″′ comprises a cutting device 14, preferably comprising a circular cutter (not illustrated), and a counter-pressure device 16. Cutting device 14 is displaceable perpendicularly to the web, so that at least one cutting edge (not illustrated) of cutting device 14 enters the web and preferably separates a sample 101 out of the web by a rotating cutting movement of the circular cutter. In doing so, counter-pressure device 16 arranged on the opposite side of the web exerts a counter-pressure for separation. Counter-pressure device 16 is preferably movable perpendicular to the web towards cutting device 14.

For separating sample 101, it is preferred that the separating devices 12′, 12″, 12″′ comprise an ejection device (not illustrated) that ejects the cut-out sample 101 out of the web.

The separated sample 101 falls into a collecting device 30′, 30″, 30″′, preferably comprising a drawer. The drawer of collecting device 30′, 30″, 30″′ makes it easy to remove the samples 101.

Thus, sample 101 is separated out of the web in a state in which the separating device displaces synchronized with the web. This ensures optimum separation, in particular without cutting into other areas of the web and/or clean separation.

Gantry 22 is moved by the driving device in the linear modules 24 in a stroke movement along the direction of movement 34. Here, gantry 22 is initially in a starting position in the linear modules 24, which is opposite to the direction of arrow 32. As soon as a sample 101 is to be separated, gantry 22 is accelerated by the driving device in the direction of arrow 32. When gantry 22 has reached the speed of the web, sample 101 is separated by means of separating devices 12′, 12″, 12″′, wherein gantry 22 continues to move at a speed corresponding to the web speed until the separation process is completed. As soon as the separation is complete, the gantry has moved in particular by a stroke length in the linear module 24 in the direction of arrow 32 and is in a deflected position. Gantry 22 is then moved back to its starting position.

The outer separating devices 12′, 12″′ are movable transversely to the web direction by means of a linear bearing 20. In particular, the separating devices 12′, 12″′ can be detachably fixed in various positions. The transverse movability of the separating devices 12′, 12″′ makes it particularly advantageous to take samples from edge areas of webs with different web widths.

The central separating device 12″ is immovable in the transverse direction.

The control of device 10, in particular for controlling the linear modules 24 and/or for controlling the separating devices 12′, 12″, 12″′ and/or for evaluating the web speed detected by the sensor, is preferably carried out by a controller (not illustrated).

1. A device for removing a section from a web, in particular a film web, comprising
at least one separating device for separating the section out of the web, and
a guiding device,
wherein the guiding device movably guides the separating device in the direction of movement of the web.

2. The device according to claim 1, wherein the guiding device is set up to accelerate the separating device in the direction of movement of the web.

3. The device according to claim 1, wherein the guiding device is set up to move the separating device at a speed synchronized with the web speed, in particular at an identical speed.

4. The device according to claim 1, wherein the separating device is set up to separate the section when the web speed is reached and/or during a movement of the separating device at web speed.

5. The device according to claim 1, further comprising a sensor for detecting the web speed.

6. The device according to claim 5, wherein the sensor comprises a rotary encoder, in particular a contact-based rotary encoder.

7. The device according to claim 1, further comprising a controller, wherein the controller is set up to synchronize the speed of the separating device with the web speed and/or to trigger the separation of the section out of the web when the speed of the separating device is synchronized with the web speed.

8. The device according to claim 1, wherein the separating device is displaceable, in particular adjustable, transversely to the web.

9. The device according to claim 1, wherein the separating device comprises a circular cutter, in particular a rotating one.

10. The device according to claim 1, wherein a cutting device and/or a counter-pressure device of the separating device is configured to be movable perpendicular to the web.

11. The device according to claim 1, further comprising a collecting device, in particular comprising a drawer, for the separated sections.

12. The device according to claim 1, wherein the device comprises several separating devices for separating several sections, which are arranged next to one another, in particular transversely to the web.

13. The device according to claim 1, wherein the guiding device comprises a linear module, in particular having a toothed belt axis, for linear guidance of the separating device relative to the web.

14. The device according to claim 1, further comprising a web threading connected to the guiding device, in particular having at least one guiding roller, for arranging the web relative to the separating device.

15. A system for processing a web, in particular a film web, comprising
a web conveying device, in particular comprising the web, and
a device according to claim 1,
wherein the device is arranged to remove a section from the web.

16. A method for removing a section from a web, in particular with a device according to claim 1,
comprising the steps of:
moving a separating device at a speed synchronized with the web speed, in particular at an identical speed, and
separating the section out of the web.
